(19) United States
(12) Patent Application Publication
(10) Pub. No.: US 2024/0391339 A1
(43) Pub. Date: Nov. 28, 2024

(54) VEHICLE AND INTER-VEHICLE POWER FEED SYSTEM

(71) Applicant: SUBARU CORPORATION, Tokyo (JP)

(72) Inventor: Hideaki KATO, Tokyo (JP)

(21) Appl. No.: 18/660,037

(22) Filed: May 9, 2024

(30) Foreign Application Priority Data
May 22, 2023 (JP) 2023-083902

(51) Int. Cl. B60L 53/57; B60L 53/14; B60L 53/66; H02J 7/00

(52) U.S. Cl. CPC B60L 53/57; B60L 53/14; B60L 53/66; H02J 7/0048; B60L 2260/54

(57) ABSTRACT

A vehicle includes an amount-of-power calculator, a power reception necessity determiner, a power transmission permissibility determiner, and a power transmission determiner. The amount-of-power calculator calculates an amount of necessary power for the vehicle. The power reception necessity determiner determines whether or not power reception of the vehicle from one or more other vehicles is necessary. The power transmission permissibility determiner determines whether or not power transmission from the vehicle to the one or more other vehicles is permissible. When two or more out of the vehicle and the one or more other vehicles make requests for the power reception, the power transmission determiner compares calculation results of the amount-of-power calculator of the vehicle and respective amount-of-power calculators of the one or more other vehicles, to determine priority of the power reception of the vehicle and the one or more other vehicles.

### CROSS-REFERENCE TO RELATED APPLICATIONS

The present application claims priority from Japanese Patent Application No. 2023-083902 filed on May 22, 2023, the entire contents of which are hereby incorporated by reference.

### BACKGROUND

The disclosure relates to a vehicle and an inter-vehicle power feed system.

Japanese Unexamined Patent Application Publication (JP-A) No. 2005-210843 discloses a power supply system using a vehicle. The vehicle receives electric power supply from the outside of the vehicle when an amount of electric power of the vehicle is insufficient, and supplies surplus electric power to the outside of the vehicle when the amount of electric power of the vehicle is surplus.

The power supply system is configured to transmit electric power by, for example, electromagnetic waves to a physically remote location that is not electrically coupled by, for example, a power transmission line. A vehicle power supply device mounted on the vehicle mainly includes an antenna, an oscillation/rectification circuit, and a controller. Similarly, a roadside power supply device installed on a road mainly includes an antenna, an oscillation/rectification circuit, and a controller.

In the vehicle power supply device of the vehicle, the controller checks remaining capacity of a battery at predetermined time intervals or receives a signal indicating that a battery voltage has fallen below a predetermined value, from a battery voltage sensor. Thus, the controller detects shortage of the remaining capacity of the battery.

### SUMMARY

An aspect of the disclosure provides a vehicle configured to transmit electric power to one or more other vehicles and receive electric power from the one or more other vehicles. The vehicle includes an amount-of-power calculator, a power reception necessity determiner, a power transmission permissibility determiner, and a power transmission determiner. The amount-of-power calculator is configured to calculate an amount of necessary power for the vehicle. The power reception necessity determiner is configured to determine whether or not power reception of the vehicle from the one or more other vehicles is necessary, based on a calculation result of the amount-of-power calculator. The power transmission permissibility determiner is configured to determine whether or not power transmission from the vehicle to the one or more other vehicles is permissible, based on the calculation result of the amount-of-power calculator. The power transmission determiner is configured to receive calculation results of respective amount-of-power calculators from the one or more other vehicles coupled to the vehicle, and determine one or both of priority of the power reception among the vehicle and the one or more other vehicles, and an amount of the power reception. The power transmission determiner is configured to, when two or more out of the vehicle and the one or more other vehicles request the power reception, compare the calculation result of the amount-of-power calculator of the vehicle and the calculation results of the respective amount-of-power calculators, to determine the priority.

An aspect of the disclosure provides an inter-vehicle power feed system. The inter-vehicle power feed system includes an external charger, and is configured to perform power transmission and power reception between vehicles coupled together through the external charger. The external charger includes an amount-of-power calculator, a power reception necessity determiner, a power transmission permissibility determiner, and a power transmission determiner. The amount-of-power calculator is configured to calculate an amount of necessary power for each of the vehicles. The power reception necessity determiner is configured to determine for each of the vehicles whether or not the power reception is necessary, based on a calculation result of the amount-of-power calculator. The power transmission permissibility determiner is configured to determine for each of the vehicles whether or not the power transmission is permissible, based on the calculation result of the amount-of-power calculator. The power transmission determiner is configured to determine one or both of priority of the power reception of the vehicles and an amount of the power reception. The power transmission determiner is configured to, when it is determined that the power reception is necessary for two or more out of the vehicles, determine the priority of the power reception of the vehicles that request the power reception, based on the calculation result of the amount-of-power calculator.

An aspect of the disclosure provides a vehicle configured to transmit electric power to one or more other vehicles and receive electric power from the one or more other vehicles. The vehicle includes circuitry. The circuitry is configured to calculate an amount of necessary power for the vehicle. The circuitry is configured to determine whether or not power reception of the vehicle from the one or more other vehicles is necessary, based on a calculation result of the amount of necessary power. The circuitry is configured to determine whether or not power transmission from the vehicle to the one or more other vehicles is permissible, based on the calculation result of the amount of necessary power. The circuitry is configured to receive calculation results of respective amount sof necessary power from the one or more other vehicles coupled to the vehicle, and determine one or both of priority of the power reception among the vehicle and the one or more other vehicles, and an amount of the power reception. The circuitry is configured to, when two or more out of the vehicle and the one or more other vehicles request the power reception, compare the calculation result of the amount-of-power calculator of the vehicle and the calculation results of the respective amounts of necessary power the one or more other vehicles, to determine the priority.

An aspect of the disclosure provides an inter-vehicle power feed system. The inter-vehicle power feed system includes an external charger, and is configured to perform power transmission and power reception between vehicles coupled together through the external charger. The external charger includes circuitry. The circuitry is configured to calculate an amount of necessary power for each of the vehicles. The circuitry is configured to determine for each of the vehicles whether or not the power reception is necessary, based on a calculation result of the amount of necessary power. The circuitry is configured to determine for each of the vehicles whether or not the power transmission is permissible, based on the calculation result of the amount of necessary power. The circuitry is configured to determine one or both of priority of the power reception of the vehicles and an amount of the power reception. The circuitry is configured to, when determining that the power reception is necessary for two or more out of the vehicles, determine the priority of the power reception of the vehicles that request the power reception, based on the calculation result of the amount of necessary power.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram of an inter-vehicle power feed system according to an embodiment of the disclosure and a vehicle to be used in the inter-vehicle power feed system.

FIG. 2 is a flowchart of a control method of the inter-vehicle power feed system according to the embodiment of the disclosure.

FIG. 3 is a flowchart of the control method of the inter-vehicle power feed system according to the embodiment of the disclosure.

### DETAILED DESCRIPTION

In the power supply system described in JP-A No. 2005-210843, the vehicle power supply device recovers regenerative energy and transmits electric power to a battery, and thereby accumulate surplus electric power while traveling. Thus, the vehicle power supply device is configured to transmit surplus electric power to the roadside power supply device. When transmitting surplus electric power to the outside of the vehicle, it is desirable to determine an amount of power transmission and perform the power transmission, to prevent the vehicle from falling into power shortage after the power transmission.

However, the vehicle power supply device described above is configured to simply turn regenerative energy recovered while traveling into surplus electric power, without consideration of an amount of electric power to be consumed afterwards by, for example, movements of the vehicle. As a result, there is a concern that the power transmission of surplus electric power from the vehicle power supply device to the roadside power supply device may cause power shortage of the vehicle.

It is desirable to provide a vehicle and an inter-vehicle power feed system that make it possible to grasp an amount of power transmission from a power-transmitting vehicle when there are multiple vehicles making requests for charging, and give priority to a vehicle that needs urgent power reception.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description.

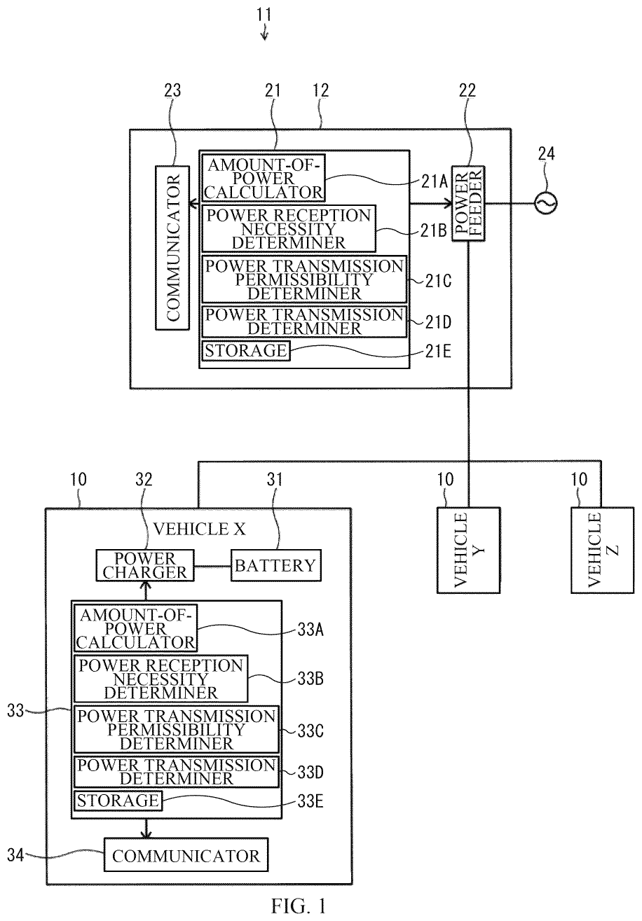

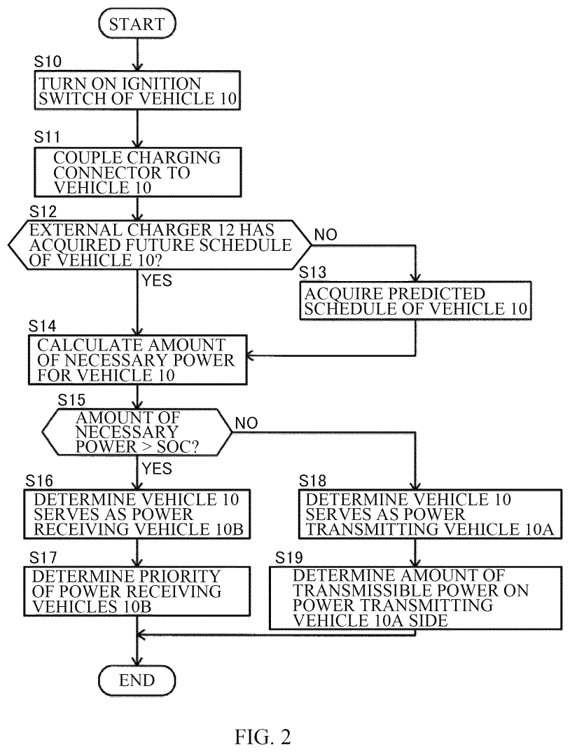

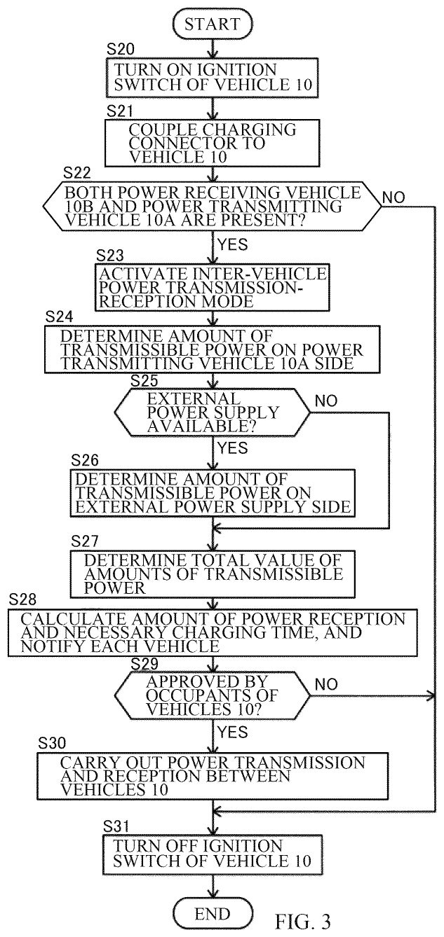

FIG. 1 is a schematic diagram of a configuration of an inter-vehicle power feed system 11 according to an embodiment of the disclosure and a configuration of a vehicle 10 to be used in the inter-vehicle power feed system 11. FIG. 2 is a flowchart of a control method of the inter-vehicle power feed system 11 according to this embodiment, to determine a power transmitting vehicle 10A or a power receiving vehicle 10B. FIG. 3 is a flowchart of the control method of the inter-vehicle power feed system 11 according to this embodiment.

As illustrated in FIG. 1, the inter-vehicle power feed system 11 of this embodiment may include, for example, an external charger 12 and multiple vehicles 10 coupled to the external charger 12. The vehicles 10 may include the power transmitting vehicle 10A and the power receiving vehicle 10B. The power transmitting vehicle 10A refers to a vehicle transmitting electric power from the vehicle itself to another vehicle. The power receiving vehicle 10B refers to a vehicle receiving electric power from another vehicle to the vehicle itself. Two or more vehicles 10 may each be coupled to the external charger 12 by a cable, and serve as the power transmitting vehicle 10A or the power receiving vehicle 10B in accordance with, for example, an SOC (State Of Charge) of a battery 31 of the vehicle 10.

In the following, as illustrated in FIG. 1, description is given of a case where three vehicles 10, i.e., vehicles X, Y, and Z, are coupled to the external charger 12 by the cables to implement the inter-vehicle power feed system 11. However, this case is non-limiting. For example, four or more vehicles 10 may be coupled to the external charger 12 by the cables to implement the inter-vehicle power feed system 11.

The external charger 12 may include, for example, an equipment controller 21, a power feeder 22, and a communicator 23. The external charger 12 in this embodiment may include, for example, a charging station provided in a town, or charging facilities provided in a detached house or a condominium.

The equipment controller 21 may include, for example, a CPU (Central Processing Unit), a ROM (Read Only Memory), and a RAM (Random Access Memory). The equipment controller 21 may include, for example, an amount-of-power calculator 21A, a power reception necessity determiner 21B, a power transmission permissibility determiner 21C, and a power transmission determiner 21D. The equipment controller 21 may include an electronic control unit (ECU) including one or more processors configured to calculate, for example, amounts of power of the coupled vehicles 10.

As described later in detail, the amount-of-power calculator 21A may calculate an amount of necessary power for future travel of each of the vehicle 10, with respect to the vehicles 10 coupled to the external charger 12. The power reception necessity determiner 21B may compare the calculated amount of power with the SOC of the battery 31 of the subject vehicle, and determine whether or not power reception from other vehicles is necessary. The power transmission permissibility determiner 21C may compare the calculated amount of power with the SOC of the battery 31 of the subject vehicle, determine whether or not power transmission to other vehicles is permissible, and calculate an amount of transmissible power to other vehicles. The power transmission determiner 21D may determine whether the vehicle 10 coupled to the external charger 12 serves as the power transmitting vehicle 10A or whether the vehicle 10 coupled to the external charger 12 serves as the power receiving vehicle 10B, by using determination results of the power reception necessity determiner 21B and the power transmission permissibility determiner 21C. Furthermore, the power transmission determiner 21D may determine priority of the multiple power receiving vehicles 10B and calculate a total amount of power with respect to the amounts of transmissible power of the multiple power transmitting vehicles 10A.

The equipment controller 21 may include a storage 21E. The storage 21E may include, for example, a nonvolatile memory such as an EEPROM (Electrically Erasable Programmable Read-only Memory). The storage 21E may hold various kinds of data to be involved in calculation by the equipment controller 21, and one or more programs to be executed by the one or more processors.

The power feeder 22 may be coupled to a power supply 24. For example, when the external charger 12 is disposed in, for example, a garage of a house, a commercial power supply may be used as the power supply 24. Moreover, an unillustrated charging connector may be coupled to the power feeder 22 of the vehicle 10 by a cable. The power feeder 22 may convert AC power supplied from the power supply 24 into DC power, and transmit the DC power to the battery 31 of the vehicle 10 through the charging connector and a power charger 32.

Moreover, in this embodiment, electric power charged in the battery 31 of the vehicle 10 may be also used as the power supply 24. The power feeder 22 may directly supply electric power transmitted from the vehicle 10 to the power charger 32 of another vehicle 10. In this case, unlike a commercial power supply, an amount of power supply increases, making it possible to perform high-output rapid charging, and substantially shorten charging time.

The communicator 23 is configured to communicate with, for example, the vehicle 10 or a server device through a network such as the Internet or a telephone network. As described later in detail, the equipment controller 21 may acquire various kinds of data, e.g., the SOC of the battery 31, a future schedule, and a travel history, from the vehicle 10 through the communicator 23, to calculate, for example, the amount of necessary power for the vehicle 10 in the future.

The vehicle 10 may include, for example, a BEV (Battery Electric Vehicle), an HEV (Hybrid Electric Vehicle), and a PHEV (Plug-in Hybrid Electric Vehicle).

The vehicle 10 may include the battery 31. The battery 31 may include, for example, a secondary battery such as a nickel-hydrogen battery or a lithium-ion battery, or a solid-state battery. The battery 31 may supply electric power to, for example, a motor generator as a driving source of the vehicle 10. The motor generator may generate electric power on the occasion of deceleration of the vehicle 10, and the battery 31 may be charged with electric power generated by the motor generator. This makes it possible for the battery 31 to transmit accumulated electric power to the battery 31 of another vehicle 10.

The power charger 32 may include an unillustrated charging port for the vehicle 10. The power charger 32 may be electrically coupled to the charging connector of the external charger 12. The power charger 32 may be coupled to the battery 31 and measure a charging current flowing through the battery 31 and a voltage of the battery 31. The power charger 32 may be controlled by a vehicle controller 33, and supply electric power from the external charger 12 to the battery 31, or transmit electric power from the battery 31 to the external charger 12.

The vehicle controller 33 may include, for example, a CPU, a ROM, and a RAM. The vehicle controller 33 may include an electronic control unit (ECU) including one or more processors to make, for example, various kinds of calculation to control, for example, an unillustrated driving device. The vehicle controller 33 may include, for example, an amount-of-power calculator 33A, a power reception necessity determiner 33B, a power transmission permissibility determiner 33C, and a power transmission determiner 33D, to calculate, for example, the amount of necessary power for the vehicle 10 in the future.

As described later in detail, the amount-of-power calculator 33A may calculate the amount of necessary power for the future travel of the subject vehicle. The power reception necessity determiner 33B may compare the calculated amount of power with the SOC of the battery 31 of the subject vehicle, and determine whether or not power reception from other vehicles is necessary. The power transmission permissibility determiner 33C may compare the calculated amount of power with the SOC of the battery 31 of the subject vehicle, determine whether or not power transmission to other vehicles is permissible, and calculate an amount of transmissible power. The power transmission determiner 33D may determine whether the subject vehicle serves as the power transmitting vehicle 10A or whether the subject vehicle serves as the power receiving vehicle 10B, by using determination results by the power reception necessity determiner 33B and the power transmission permissibility determiner 33C. Furthermore, for example, the power transmission determiner 33D may determine priority of the multiple power receiving vehicles 10B coupled to the external charger 12, and calculate a total amount of power with respect to the amounts of transmissible power of the multiple power transmitting vehicles 10A.

The vehicle controller 33 may further include a storage 33E. The storage 33E may include, for example, a nonvolatile memory such as an EEPROM. The storage 33E may hold various kinds of data to be involved in calculation by the vehicle controller 33 and one or more programs to be executed by the one or more processors.

The communicator 34 is configured to communicate with, for example, the external charger 12 or a server device through a network such as the Internet or a telephone network. As described, the communicator 34 is configured to transmit various kinds of data regarding the vehicle 10, e.g., the SOC of the battery 31, the future schedule, and the travel history, to the external charger 12.

It is to be noted that FIG. 1 illustrates a situation in which the three vehicles 10, namely, the vehicles X, Y, and Z, are coupled to the external charger 12. Configurations of the vehicles Y and Z are the same as those of the vehicle X, and the description and the illustration thereof is omitted with reference to the forgoing description.

With reference to FIG. 2, description is given next of a control method of determining whether the vehicles X, Y, and Z coupled to the external charger 12 each serve as the power transmitting vehicle 10A or whether the vehicles X, Y, and Z coupled to the external charger 12 each serve as the power receiving vehicle 10B. Description is also given of a method of determining the priority when there are multiple vehicles 10 determined as serving as the power receiving vehicles 10B and a method of calculating the amounts of transmissible power of the vehicles 10 determined as serving as the power transmitting vehicles 10A. In the inter-vehicle power feed system 11 of this embodiment, the external charger 12 may make, for example, the determination mentioned above for each of the vehicles X, Y, and Z. However, the following description is made, with the vehicles X, Y, and Z generally referred to as the vehicles 10, and redundant description is omitted.

As illustrated in FIG. 2, in step S10, the occupant gets on the vehicle 10 and presses an unillustrated ignition switch, and thereupon, the vehicle 10 is brought to an ignition-on state. Thereafter, in step S11, the occupant stops the vehicle 10 around the external charger 12, and couples the charging connector of the external charger 12 to the power charger 32 of the vehicle 10.

In step S12, the external charger 12 may start communication with the vehicle 10 through the communicators 23 and 34, and acquire the future schedule data regarding the vehicle 10. In affirmation (YES) in step S12, when the storage 33E of the vehicle 10 holds the future schedule data related to a course of the future travel of the vehicle 10, the external charger 12 may acquire the future schedule data and cause the flow to proceed to step S14. It is to be noted that the future schedule data may include, for example, data related to the course of travel of the vehicle 10 from the current time point to three days later. The external charger 12 may also acquire data to be involved in the calculation of the amount of power described later, e.g., the SOC of the battery 31 and latest fuel efficiency data regarding the vehicle 10.

In negation (NO) in step S12, when the storage 33E of the vehicle 10 does not hold the future schedule data, the external charger 12 may cause the flow to proceed to step S13 without acquiring the future schedule data.

In step S13, the external charger 12 may acquire previous travel history data regarding the vehicle 10 through the communicators 23 and 34. For example, the external charger 12 may acquire the travel history data related to the course of travel of the vehicle 10 from the current time point to one month ago. The travel history data may be held in the storage 33E of the vehicle 10. The equipment controller 21 may estimate a travel pattern of the vehicle 10 based on the previous travel history data. The travel pattern may include, for example, that the vehicle 10 is used for commuting to work, or that the vehicle 10 is used for shopping to a nearby supermarket as usual. The equipment controller 21 may generate predicted schedule data corresponding to the day of the week and the time, based on the estimated travel pattern, store the predicted schedule data in the storage 21E, and cause the flow to proceed to step S14. The external charger 12 may also acquire the data to be involved in the calculation of the amount of power described later, e.g., the SOC of the battery 31 and the latest fuel efficiency data regarding the vehicles 10.

In step S14, the equipment controller 21 may calculate the amount of necessary power for the vehicle 10 from the current time point to three days later. The equipment controller 21 may calculate a cruising distance of the vehicle 10 from the current time point to three days later, based on the predicted schedule data and the future schedule data, by using, for example, road map data held in advance in the storage 21E. The equipment controller 21 may calculate the amount of necessary power for the vehicle 10 in the future, by using, for example, the latest fuel efficiency data regarding the vehicle 10.

In step S15, the equipment controller 21 may compare the calculated amount of power with the SOC of the battery 31. In affirmation (YES) in step S15, the amount of power is larger than the SOC of the battery 31, and the equipment controller 21 may cause the flow to proceed to step S16. In step S16, the equipment controller 21 may determine that the vehicle 10 needs to be charged, determine that the vehicle 10 serves as the power receiving vehicle 10B, and cause the flow to proceed to step S17.

In step S17, when there are multiple power receiving vehicles 10B, the equipment controller 21 may determine the priority of charging of the power receiving vehicles 10B. As described, the equipment controller 21 may calculate an amount of power shortage for each vehicle 10, and hold the cruising distance from the current time point to three days later. As a result, the equipment controller 21 may determine the priority of the multiple power receiving vehicles 10B while comparing, for example, the latest travel schedules of the vehicles 10 and the amounts of power shortage. When there is one power receiving vehicle 10B, the determination of the priority in step S17 may be skipped.

In negation (NO) in step S15, when the amount of power mentioned above is smaller than the SOC of the battery 31, the equipment controller 21 may cause the flow to proceed to step S18. In step S18, the equipment controller 21 may determine that the vehicle 10 has surplus electric power, determine that the vehicle 10 serves as the power transmitting vehicle 10A, and cause the flow to proceed to step S19.

In step S19, the equipment controller 21 may calculate the amount of transmissible power with respect to the power transmitting vehicle 10A. As described, when comparing the amount of power mentioned above with the SOC of the battery 31, the equipment controller 21 may determine a difference between the amount of power mentioned above and the SOC of the battery 31 as the amount of transmissible power.

As described, in the inter-vehicle power feed system 11 of this embodiment, the external charger 12 may determine whether the coupled vehicle 10 serves as the power receiving vehicle 10B or whether the coupled vehicle 10 serves as the power transmitting vehicle 10A. The equipment controller 21 may determine that the vehicle 10 serves as the power transmitting vehicle 10A and also calculate the amount of transmissible power. As a result, in the inter-vehicle power feed system 11, it is possible to prevent electric power equal to or larger than the amount of transmissible power from being transmitted from the power transmitting vehicle 10A to the power receiving vehicle 10B. Hence, it is possible to prevent power shortage of the power transmitting vehicle 10A when the power transmitting vehicle 10A travels within at least three days from the current time point.

Description is given next, with reference to FIG. 3, of a method of controlling the inter-vehicle power feed system 11. The method is implemented between the vehicles X, Y, and Z coupled to the external charger 12. In the following, description is made, with the vehicles X, Y, and Z referred to as the vehicles 10.

As illustrated in FIG. 3, in step S20, the occupant gets on the vehicle 10 and presses the unillustrated ignition switch, and thereupon, the vehicle 10 is brought to the ignition-on state. Thereafter, in step S21, the occupant stops the vehicle 10 around the external charger 12, and couples the charging connector of the external charger 12 to the power charger 32 of the vehicle 10.

In step S22, as described with reference to FIG. 2, the equipment controller 21 of the external charger 12 may determine whether each of the coupled vehicles 10 serves as the power receiving vehicle 10B or whether each of the coupled vehicles 10 serves as the power transmitting vehicle 10A. In affirmation (YES) in step S22, the equipment controller 21 may determine that both the vehicle 10 serving as the power receiving vehicle 10B and the vehicle 10 serving as the power transmitting vehicle 10A are included in the vehicles 10 coupled to the external charger 12, and the equipment controller 21 may cause the flow to proceed to step S23.

In step S23, the external charger 12 may activate an inter-vehicle power transmission-reception mode and give a notification to each of the vehicles 10 through the communicators 23 and 34.

In step S24, the equipment controller 21 may determine the amount of transmissible power on the vehicle 10 side. As described with reference to FIG. 2, in step S19, the external charger 12 may calculate the amount of transmissible power of the vehicle 10 determined as serving as the power transmitting vehicle 10A. The equipment controller 21 may accumulate the amounts of transmissible power of the power transmitting vehicles 10A, and determine the total amount of electric power with respect to the amounts of transmissible power on the vehicle 10 side.

In step S25, the equipment controller 21 may determine whether or not the power supply 24 is available as an external power supply. In affirmation (YES) in step S25, the equipment controller 21 may determine that the power supply 24 is available. Thus, in step S26, the equipment controller 21 may determine the amount of transmissible power from the external charger 12 side.

In step S27, the equipment controller 21 may accumulate the amount of transmissible power on the vehicle 10 side determined in step S24 and the amount of transmissible power on the external charger 12 side determined in step S26, and determine the total amount of transmissible power.

In step S28, when there are multiple power receiving vehicles 10B, the equipment controller 21 may determine the priority of the power receiving vehicles 10B as described in step S17 in FIG. 2. Moreover, the equipment controller 21 may calculate the amount of power reception to be distributed for each of the power receiving vehicles 10B from the total amount of transmissible power calculated in step S27. The equipment controller 21 may calculate necessary charging time based on the amount of power reception to be distributed to each of the power receiving vehicles 10B.

Thereafter, the equipment controller 21 may communicate with the vehicles 10 through the communicators 23 and 34, and notify each of the vehicles 10 of whether the relevant vehicle 10 is determined as serving as the power receiving vehicle 10B or whether the relevant vehicle 10 is determined as serving as the power transmitting vehicle 10A, and the necessary charging time. Thus, the vehicle 10 may notify the occupant of the contents of the notification by using, for example, a display of a navigation device.

In step S29, on the vehicle 10 side, the occupant confirms the contents of the notification displayed on the display. In affirmation (YES) in step S29, the occupants of all the vehicles 10 give approval of the contents of the notification, and the equipment controller 21 may cause the flow to proceed to step S30.

In step S30, the equipment controller 21 may communicate with the vehicles 10 through the communicators 23 and 34, confirm that the contents of the notification have been approved by all the vehicles 10, and perform the power transmission and reception between the vehicles 10. Thereafter, in step S31, the power transmission and reception between the vehicles 10 is finished, causing an end of the inter-vehicle power transmission-reception mode. Thus, the equipment controller 21 may communicate with the vehicles 10 through the communicators 23 and 34, and notify each of the vehicles 10 of the end mentioned above. Thereafter, the occupant removes the charging connector from the vehicle 10, moves the vehicle 10 to, for example, a parking lot, and parks the vehicle. The occupant presses the ignition switch of the vehicle 10, and the vehicle 10 is brought to an ignition-off state.

Meanwhile, in negation (NO) in step S29, at least one of the vehicles 10 does not give the approval of the contents of the notification, and the equipment controller 21 may cause the flow to proceed to step S31. Similarly, in negation (NO) in step S22, it is determined that either the vehicle 10 serving as the power receiving vehicle 10B or the vehicle 10 serving as the power transmitting vehicle 10A is not included in the vehicles 10 coupled to the external charger 12, and the equipment controller 21 may cause the flow to proceed to step S31.

In this case, the occupant removes the charging connector from the vehicle 10 without performing the power transmission and reception between the vehicles 10, moves the vehicle 10 to, for example, a parking lot, and parks the vehicle. When the occupant presses the ignition switch of the vehicle 10, the vehicle 10 is brought to the ignition-off state.

As described, in the inter-vehicle power feed system 11 of this embodiment, the vehicles 10 coupled to the external charger 12 includes both the vehicle 10 serving as the power receiving vehicle 10B and the vehicle 10 serving as the power transmitting vehicle 10A. Hence, it is possible to perform the power transmission and reception between the vehicles 10. Making it possible to perform the power transmission and reception between the vehicles 10 leads to high-output charging and reduction in the necessary charging time by rapid charging.

In the inter-vehicle power feed system 11 of this embodiment, description is given of a case where the multiple vehicles 10 are coupled to the external charger 12, and the equipment controller 21 of the external charger 12 determines, for example, the amount of necessary power for each of the vehicles 10 and determine whether each of the vehicles 10 serves as the power receiving vehicle 10B or whether each of the vehicles 10 serves as the power transmitting vehicle 10A. However, this case is non-limiting. As illustrated in FIG. 1, the vehicle controller 33 of each vehicle 10 may also be configured to make the same control as the equipment controller 21 described above. In an alternative case, the external charger 12 may select one vehicle 10 as a host from the coupled vehicles 10, and the inter-vehicle power feed system 11 may be implemented by the selected vehicle 10.

In another alternative case, each vehicle 10 may allow the vehicle controller 33 of the subject vehicle to determine the amount of necessary power for the vehicle 10 and determine whether the vehicle 10 serves as the power receiving vehicle 10B or whether the vehicle 10 serves as the power transmitting vehicle 10A, as illustrated in FIG. 2. Thereafter, each vehicle 10 may transmit the determination results to the external charger 12 through the communicators 23 and 34. Thereafter, the equipment controller 21 may carry out the control subsequent to step S22 in FIG. 3.

Furthermore, description is given of a case where, in step S29 in FIG. 3, when any one of the multiple vehicles 10 coupled to the external charger 12 does not give the approval, the power transmission and reception between the vehicles 10 is not performed, and the inter-vehicle power feed system 11 is ended. However, this case is non-limiting. For example, when any one of the vehicles 10 does not give the approval, the charging connector may be disconnected from the vehicle 10 that does not give the approval. Thereafter, the flow may be returned to step S24 and restarted at the accumulation of the amounts of transmissible power.

In the vehicle according to the aspects of the disclosure, the inter-vehicle power feed system is constituted in which electric power is transmitted or received between the multiple vehicles coupled by, for example, the cables. The amount-of-power calculator or the circuitry is configured to calculate the amount of necessary power for the subject vehicle. The power transmission determiner or the circuitry is configured to compare the calculated amount with the SOC of the battery of the subject vehicle by using the calculation result, to determine whether the subject vehicle serves as the power transmitting vehicle or whether the subject vehicle serves as the power receiving vehicle. With this vehicle, when there are multiple power receiving vehicles, the power transmission determiner or the circuitry is configured to determine the priority of the power receiving vehicles. Hence, it is possible to perform power transmission and reception between the vehicles in accordance with actual necessity of charging.

In the inter-vehicle power feed system according to the aspects of the disclosure, the amount-of-power calculator or the circuitry of the external charger is configured to calculate the amount of necessary power for each of the multiple vehicles coupled to the external charger. The power transmission determiner or the circuitry of the external charger is configured to compare the calculated amount with the SOC of the battery of the subject vehicle, by using the calculation result, to determine whether each of the multiple coupled vehicles serves as the power transmitting vehicle or whether each of the multiple coupled vehicles serves as the power receiving vehicle. With this inter-vehicle power feed system, when there are multiple power receiving vehicles, the power transmission determiner or the circuitry of the external charger is configured to determine the priority of the power receiving vehicles. Hence, it is possible to perform the power transmission and reception between the vehicles in accordance with the actual necessity of charging.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

The equipment controller 21 of the inter-vehicle power feed system 11 and the vehicle controller 33 of the vehicle 10 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the equipment controller 21 of the inter-vehicle power feed system 11 and the vehicle controller 33 of the vehicle 10. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the equipment controller 21 of the inter-vehicle power feed system 11 and the vehicle controller 33 of the vehicle 10 illustrated in FIG. 1.

1. A vehicle configured to transmit electric power to one or more other vehicles and receive electric power from the one or more other vehicles, the vehicle comprising:
an amount-of-power calculator configured to calculate an amount of necessary power for the vehicle;
a power reception necessity determiner configured to determine whether or not power reception of the vehicle from the one or more other vehicles is necessary, based on a calculation result of the amount-of-power calculator;
a power transmission permissibility determiner configured to determine whether or not power transmission from the vehicle to the one or more other vehicles is permissible, based on the calculation result of the amount-of-power calculator; and
a power transmission determiner configured to receive calculation results of respective amount-of-power calculators from the one or more other vehicles coupled to the vehicle, and determine one or both of priority of the power reception among the vehicle and the one or more other vehicles, and an amount of the power reception, wherein
the power transmission determiner is configured to, when two or more out of the vehicle and the one or more other vehicles request the power reception, compare the calculation result of the amount-of-power calculator of the vehicle and the calculation results of the respective amount-of-power calculators of the one or more other vehicles requesting the power reception, to determine the priority.

2. The vehicle according to claim 1, wherein
the calculation result of the amount-of-power calculator includes an amount of transmissible power to the one or more other vehicles, and
the power transmission determiner is configured to accumulate the amount-of-power calculator includes an amount of transmissible power of the vehicle and amounts of transmissible power of the one or more other vehicles, and determine the amount of the power reception of each of the two or more out of the vehicle and the one or more other vehicles from each of which the request for the power reception has been received.

3. The vehicle according to claim 2, wherein
the amount-of-power calculator is configured to calculate the amount of necessary power for the vehicle by using future schedule data or predicted schedule data, the future schedule data being held in at least the vehicle, and the predicted schedule data being estimated based on previous travel history.

4. The vehicle according to claim 1, wherein
the one or more other vehicles include vehicles more than one vehicle, and
the vehicle and the one or more other vehicles are configured to be coupled together through an external charger.

5. The vehicle according to claim 2, wherein
the one or more other vehicles include vehicles more than one vehicle, and
the vehicle and the one or more other vehicles are configured to be coupled together through an external charger.

6. The vehicle according to claim 3, wherein
the one or more other vehicles include vehicles more than one vehicle, and
the vehicle and the one or more other vehicles are configured to be coupled together through an external charger.

7. An inter-vehicle power feed system comprising an external charger, and configured to perform power transmission and power reception between vehicles coupled together through the external charger,
the external charger comprising:
an amount-of-power calculator configured to calculate an amount of necessary power for each of the vehicles;
a power reception necessity determiner configured to determine for each of the vehicles whether or not the power reception is necessary, based on a calculation result of the amount-of-power calculator;
a power transmission permissibility determiner configured to determine for each of the vehicles whether or not the power transmission is permissible, based on the calculation result of the amount-of-power calculator; and
a power transmission determiner configured to determine one or both of priority of the power reception of the vehicles and an amount of the power reception, wherein
the power transmission determiner is configured to, when it is determined that the power reception is necessary for two or more out of the vehicles, determine the priority of the power reception of the vehicles that request the power reception, based on the calculation result of the amount-of-power calculator.

8. The inter-vehicle power feed system according to claim 7, wherein
the calculation result of the amount-of-power calculator includes an amount of transmissible power, and
the power transmission determiner is configured to accumulate the amount of transmissible power of each of the vehicles, and determine the amount of the power reception of each of the vehicles that request the power reception.

9. A vehicle configured to transmit electric power to one or more other vehicles and receive electric power from the one or more other vehicles, the vehicle comprising:
circuitry configured to:
calculate an amount of necessary power for the vehicle;
determine whether or not power reception of the vehicle from the one or more other vehicles is necessary, based on a calculation result of the amount of necessary power;
determine whether or not power transmission from the vehicle to the one or more other vehicles is permissible, based on the calculation result of the amount of necessary power; and
receive calculation results of respective amounts of necessary power from the one or more other vehicles coupled to the vehicle, and determine one or both of priority of the power reception among the vehicle and the one or more other vehicles, and an amount of the power reception, wherein
the circuitry is configured to, when two or more out of the vehicle and the one or more other vehicles request the power reception, compare the calculation result of the amount-of-power calculator of the vehicle and the calculation results of the respective amounts of necessary power of the one or more other vehicles requesting the power reception, to determine the priority.

10. An inter-vehicle power feed system comprising an external charger, and configured to perform power transmission and power reception between vehicles coupled together through the external charger,
the external charger comprising circuitry configured to:
calculate an amount of necessary power for each of the vehicles;
determine for each of the vehicles whether or not the power reception is necessary, based on a calculation result of the amount of necessary power;
determine for each of the vehicles whether or not the power transmission is permissible, based on the calculation result of the amount of necessary power; and
determine one or both of priority of the power reception of the vehicles and an amount of the power reception, wherein
the circuitry is configured to, when determining that the power reception is necessary for two or more out of the vehicles, determine the priority of the power reception of the vehicles that request the power reception, based on the calculation result of the amount of necessary power.
